(19) United States
(12) Patent Application Publication
(10) Pub. No.: US 2006/0176475 A1
(43) Pub. Date: Aug. 10, 2006

(54) Method and device for inspecting products

(75) Inventors: Marc Ruymen, Korbeek-Lo (BE); Eric Van Wanrooij, Nistelrode (NL); Eric Smeets, Budel (NL)

Correspondence Address: BROWDY AND NEIMARK, P.L.L.C.;624 NINTH STREET, NW, SUITE 300, WASHINGTON, DC, 20001-5303, US

(73) Assignee: Pulsarr Industrial Research B.V., Eindhoven (NL)

(21) Appl. No.: 10/549,757

(22) PCT Filed: Mar. 18, 2004
(86) PCT No.: PCT/BE04/00040

§ 371 Date: Sep. 19, 2005

(30) Foreign Application Priority Data
Mar. 18, 2003 (BE) 2003/0169

(51) Int. Cl. G01N 21/88

(52) U.S. Cl. 356/237.1

(57) ABSTRACT

Device for the inspection of products, whereby this device (1) comprises means to convey these products (2) along a track (4) in the shape of a product flow (5) extending in the width, characterised in that it comprises at least one scanner (9-10) for inspecting the products (2), whereby this scanner (9-10) is situated on one side of the aforesaid track (4).

The present invention concerns a method and a device for the inspection of products.

In particular, it is designed for the automatic detection of undesirable products in a product flow, in order to remove these products automatically, for example.

In particular, it aims a method and a device which are very suitable to be applied in the food industry, for example to sort the products foreign to food out of certain foodstuffs, in particular leaves, sprigs and pieces of waste, such as wood, plastic, stones, etcetera, or also to remove the undesirable food products from foodstuffs, such as for example discoloured, bad, mouldy or damaged food products. Even more specifically, the method and device are designed to be implemented for the inspection and/or sorting of loose food products, such as potatoes, vegetables, nuts, etcetera.

Although the invention is in the first place designed to be implemented in the above-mentioned applications, it is not excluded to use it in other fields and for other applications as well, for example for sorting ores, petrochemical products, etcetera.

It is known that products can be inspected in order to make a possible selection by conveying these products over a specific track in the shape of a product flow extending in the width and by scanning this product flow over the width of the aforesaid track, such that undesired products can be detected. Examples of this technique, whereby the products are inspected by means of a single scanner, are described among others in WO 01/00333 and WO 01/07950.

Devices are also known whereby two scanners are used which are erected in the centre above the product flow and in the centre under the product flow.

The devices known until now are disadvantageous in that the scanners are often difficult to access, especially when, in order to scan the products from different sides, use is made of a scanner erected in the centre under the product flow. Especially in the latter case, the above-mentioned scanner and the peripherals used thereby, such as lenses, mirrors and the like, become dirty in a minimum of time, as a result of which the contrast is reduced and the lower scanner is often switched off.

The present invention in general aims an improved method and device for the inspection of products, whereby a solution for the above-mentioned disadvantages is preferably also aimed for.

To this end, the invention in the first place concerns a method for the inspection of products, whereby these products are conveyed over a track in the shape of a product flow extending in the width, and these products are scanned, characterised in that at least one scanner is applied situated on one side of the above-mentioned track, in other words which is localised laterally in relation to the middle plane perpendicular of the above-mentioned track. The use of a scanner which is thus installed at or near a side of the above-mentioned track offers the advantage that at least this scanner is easily accessible, for example for maintenance or the like. Another advantage consists in that, as the scanner is not situated in the middle under the product flow, it will be less subject or not subject at all to pollution by means of dust or the like coming down from the product flow.

According to the most preferred embodiment, at least two scanners are used, situated on either side of the aforesaid track respectively.

In this manner, the products can be scanned from at least two angles, so that good scan results are obtained on the one hand, whereas both scanners remain easily accessible for maintenance or the like on the other hand, and moreover are little subject to pollution. These scanners may but must not necessarily cover the entire width of the product flow. According to a first possibility, every scanner may cover for example half of the product flow situated nearest to the scanner concerned, as a result of which the largest length of the optical path to be spanned remains restricted. According to a second possibility, every scanner may cover the entire width of the product flow, as a result of which all products, as they are being observed by both scanners, are inspected over a larger part of their perimeter than in the case where only one of such scanners is being used. Also, in this manner are obtained more reliable scan results. Also other possibilities are not excluded. Thus, a scanner situated for example on the left side of the product flow, could scan the right half, whereas a scanner situated for example on the right side could scan the left half.

The above-mentioned products are preferably scanned by means of the above-mentioned scanner or scanners along the bottom side and/or back side, in particular slantingly at an angle.

According to the most preferred embodiment, the products are inspected by the above-mentioned scanners while performing a coasting flight movement, for example while being rejected in a forward movement from a conveyor belt or the like or while performing a simple falling motion.

Further, the above-mentioned products are preferably also scanned as of the top side and/or front side by means of at least one additional scanner. Thus is obtained that the products can be easily inspected, from the top side as well as the bottom side. When at least two scanners are moreover implemented at the bottom side which, as mentioned above, cover the entire width of the product flow, this offers the advantage that the products can be inspected over their entire perimeter, without any further scanners being necessary situated at unfavourable spots, for example in the centre under the product flow. By scanning the products from three sides, it is possible to create what could be called a “full surround view”, in other words all products can then be inspected over their entire or almost entire perimeter.

The products are hereby preferably scanned from at least three sides, in main directions which, seen from the direction of movement of the products, are rotated at least 90° in relation to each other, and better still are mutually rotated some 120°.

It is clear that, as a function of the scan results, it is possible to carry out an automatic selection.

It is also clear that the invention also concerns devices for realising the above-mentioned methods. Consequently, it also concerns a device for the inspection of products, whereby this device comprises means for conveying these products over a track in the shape of a product flow extending in the width, characterised in that it comprises at least one scanner for inspecting the products, whereby this scanner is situated at, near or along one side of the above-mentioned track. Further characteristics of this device will become clear from the following description and claims.

In order to better explain the characteristics of the invention, the following preferred embodiments are described as an example only without being limitative in any way, with reference to the accompanying drawings in which:

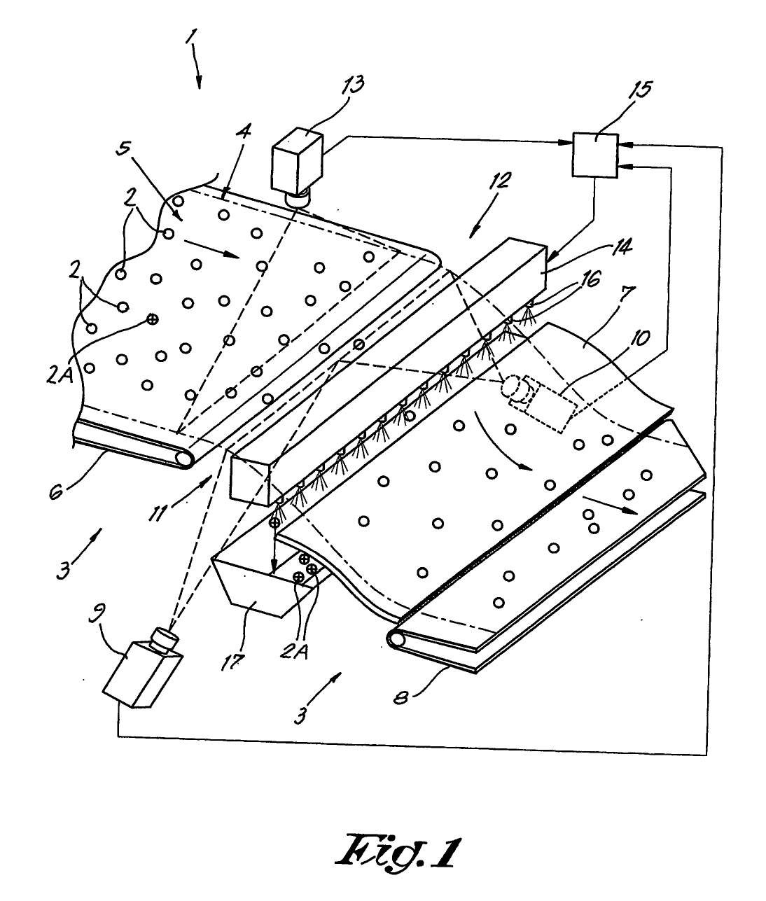

FIG. 1 schematically represents a device according to the invention;

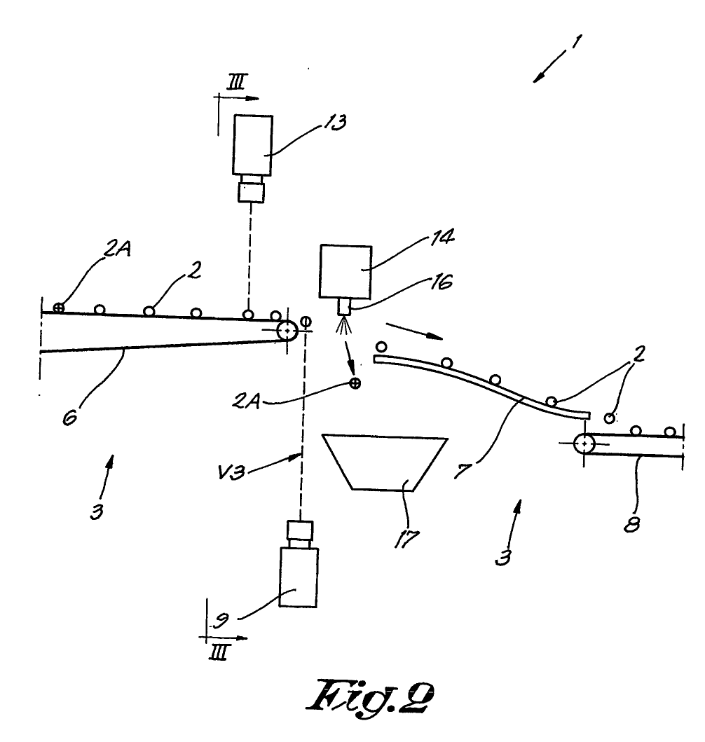

FIG. 2 represents the device from FIG. 1 seen from a side-view;

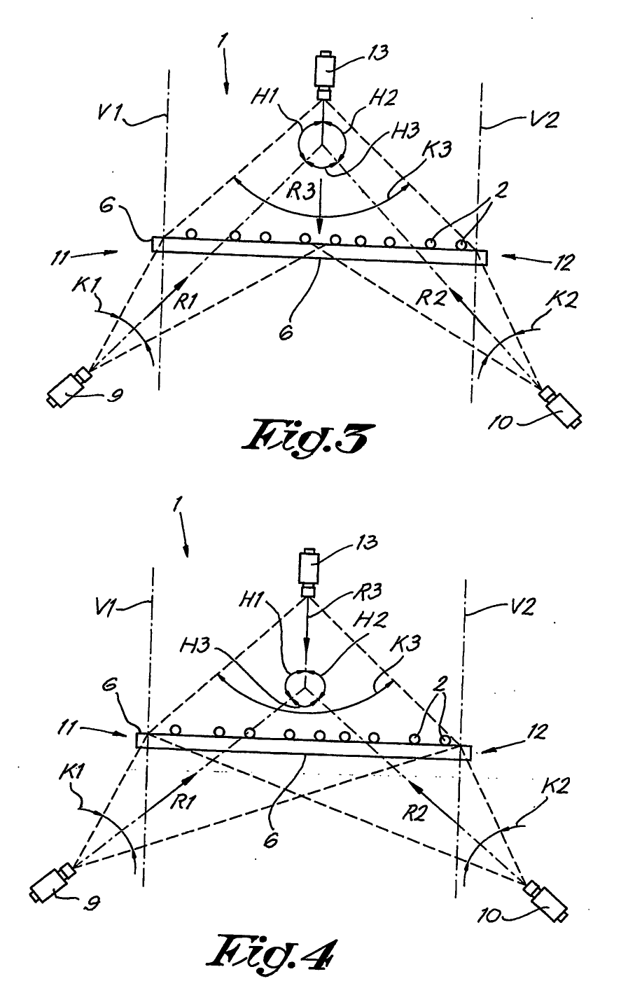

FIG. 3 represents a section according to line III-III in FIG. 2;

FIG. 4 represents a view similar to that of FIG. 3, but for a variant;

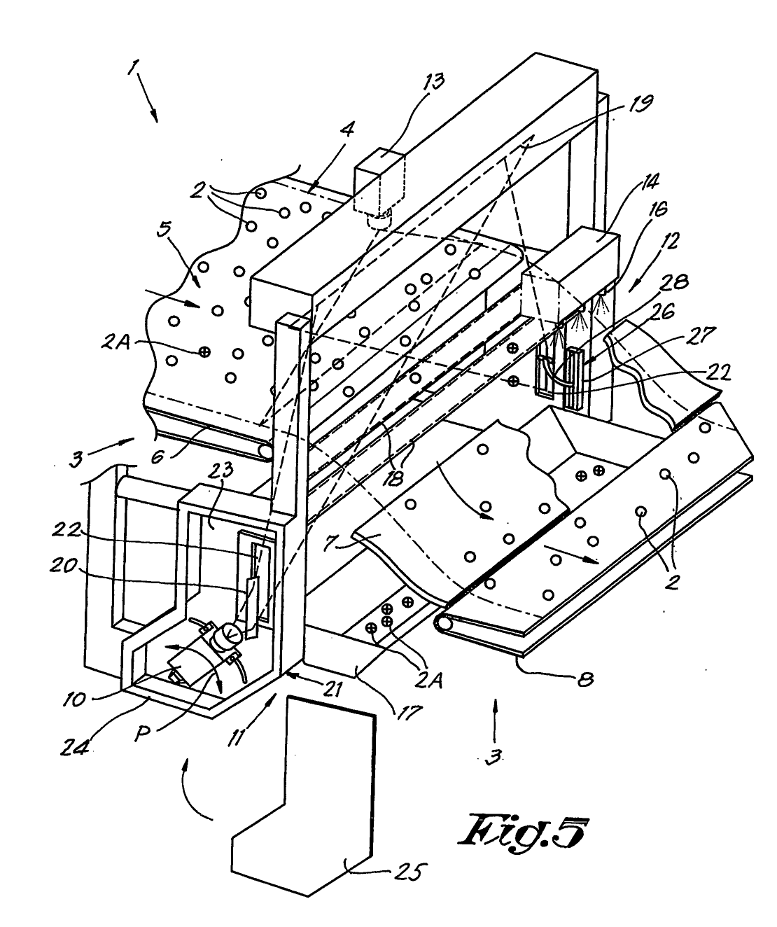

FIGS. 5, 6 and 7 represent views analogous to those of FIGS. 1 to 3, but for an embodiment represented in more detail.

As represented in FIGS. 1 to 3, the invention concerns a device 1 for the inspection of products 2, which in the given example is also designed to subject the products 2 to an automatic selection.

The device 1 comprises means 3 for conveying the products 2 over a track 4 in the shape of a product flow 5 extending in the width. In the given example, these means 3 comprise a conveyor belt 6 upon which the products 2 are provided in a manner which is not represented, for example they are shaken out on it via a charging funnel. The conveyor belt 6 is preferably driven at a relatively high speed, for example at 2 to 6 m/s, such that the products 2, at the far end of said conveyor belt 6, perform a coasting flight motion in order to be normally collected further on, either in a reservoir, or, as represented, on conveyor parts, in this case an inclined plane 7 and a conveyor belt 8, to carry off the products 2.

A special aspect of the present invention consists in that use is made of at least one scanner, and in the given example of two scanners 9-10, situated on the sides 11-12 respectively, of the above-mentioned track 4. In the given example, these scanners 9-10 are erected such that the products 2 are scanned from below, in particular in a slanting direction, according to the main directions indicated by R1 and R2.

It should be noted that the scanners 9-10, as represented in FIG. 3, are preferably situated entirely laterally along the above-mentioned track 4, in other words to the left and to the right respectively of the planes V1 and V2 indicated in FIG. 3. The scanners 9-10 are active in a plane V3 immediately following the conveyor belt 6, as indicated in FIG. 2.

The device 1 as represented also comprises one additional scanner 13 inspecting the products 2 in a conventional manner from above according to a main direction R3 diagonally to the conveyor belt 6.

Seen according to the elevation of FIG. 3, the main directions R1, R2 and R3 preferably extend at angles H1, H2 and H3 which are rotated at least 90° in relation to each other and which, better still, as represented, are rotated some 120° in relation to each other.

The scanners 9-10 can be of any nature whatsoever. They may for example consist of cameras having a certain viewing angle K1-K2-K3, whereby the observed image can then be further processed. Use can also be made of a recording element or camera which instantly perceives a very restricted area, but whereby this area moves at a very high speed over the width of the product flow 5, in other words carries out a to-and-fro scan movement, for example over the above-mentioned angles K1, K2 and K3.

Further, the device 1 comprises a unit 14 for sorting the inspected products, which is controlled via a control unit 15 as a function of the observations made by the scanners 9-10-13. This unit 14, as represented, may consist for example of a series of blow nozzles 16 which can be separately controlled, directed onto the product flow 5, such that, by briefly switching on said blow nozzle 16, a product situated underneath it, indicated by 2A in this case, can be blown out of the product flow 5, for example in a waste recipient 17 or the like.

The working of the device 1 will be explained hereafter.

When the device 1 is operational, the products 2, because of the speed at which they are moved by means of the conveyor belt 6, are thrown from said conveyor belt 6 onto the inclined plane 7. They are scanned from below, on the flight, by the scanners 9 and 10, whereas they had already been previously scanned from the top by means of the scanner 13. Thus, the products 2 can be examined for the presence of certain characteristics, for example on the basis of the observed colour, the reflection of emitted rays, the shape and/or dimensions. When a product 2A is being observed having characteristics which make it undesirable, such that it has to be removed from the product flow 5, the required blow nozzle 16 will be activated in conformity with the observation made, as a result of which this product will be blown out of the product flow 5 and ends up in the waste recipient 17 or the like. It is clear that, according to a variant, also good products can be removed from the product flow 5, whereas the undesired products are being carried further, for example when the product flow 5 contains only a limited number of good products.

By using scanners 9-10 in conformity with the present invention which are erected on the side of the track 4, it is clear that these scanners 9-10 are easier to access, are less liable to pollution and easier to maintain.

By making use of viewing angles K1 and K2, as represented in FIG. 3, the optical path between a scanner 9 or 10 and a product 2 remains relatively restricted, which has a positive effect on the scan results.

This does not exclude that it is possible to work with viewing angles K1 and K2, as represented in FIG. 4, whereby the scanner 9 as well as 10 cover the entire width of the track 4. Although the largest optical path of a product to a scanner 9 or 10 is in this case bigger than in the embodiment of FIG. 3, this offers the advantage that most products 2 are at least partially scanned in an overlapping manner by the scanners 9 and 10, which also improves the scan results. Moreover, it is possible to inspect all the products 2 in this manner, at least when also the scanner 13 is used, over practically their entire perimeter.

The scanners 9 and 10 preferably operate in one and the same plane, although this is not absolutely necessary. Also the scanner 13 preferably operates in a plane, whose intersecting line with the track 4 is situated at a short distance from the plane in which the scanners 9 and 10 operate.

As the products 2 have little or no chance to turn between the place where they are being observed by the scanner 13 and the place where they are being observed by the scanner 9 and 10, a correct detection of the upper side as well as the lower side can be guaranteed with great certainty. It is clear that the scanner 13, according to a variant, can also be erected in another place, and could also inspect the products 2 for example on the flight.

FIGS. 5 to 7 represent a device 1 which is similar to that in FIGS. 1 to 3, but in a more elaborate shape in which have also been integrated several important and advantageous technical aspects.

In this embodiment is indicated, for example, how the products 2 are irradiated by means of lamps 18 or the like, for example with visible or invisible light. The aim may be to better recognize the colours of the products 2, as well as to obtain a certain interaction between the electromagnetic radiation and certain products, on the basis of which a selection can be made, for example as described in greater detail in WO 01/07950.

As represented, also a plane 19 for forming a background can be provided in order to obtain a higher contrast and/or other effects.

Another special aspect of the embodiment from FIGS. 5 to 7 consists in that the scanners 9-10 are mainly erected according to vertical planes V4-V5 along the sides of the track 4 with their longitudinal direction and/or viewing direction. Use is also made of bending mirrors 20 in order to realise a scanning in a plane which is diagonal to the aforesaid track 4, whereby these bending mirrors 20 are preferably also situated in the planes V4 and V5, be it at an angle in relation to these planes V4 and V5. It should be noted that these bending mirrors 20 are preferably vertically directed.

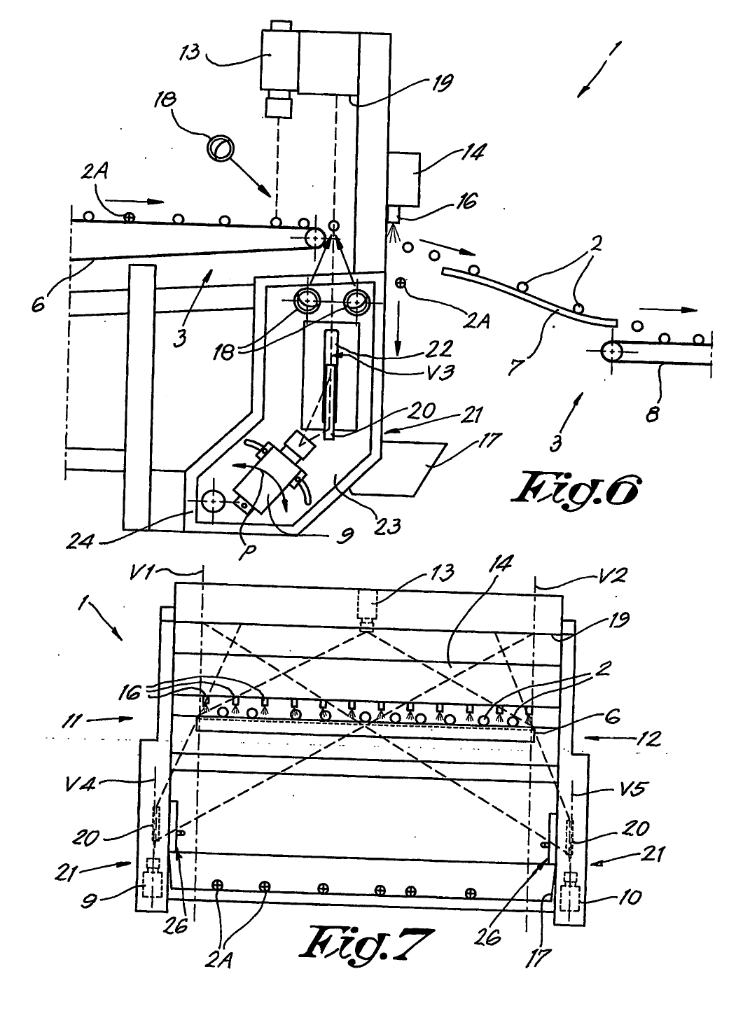

This device 1 may possibly be equipped with several adjustment facilities, for example adjusting means in order to change the position and/or size of the angle over which is being scanned, in other words the viewing angles K1 and K2. The device 1 hereby preferably at least comprises adjusting means in the shape of control elements with which such a scanner 9 or 10 can be turned in the aforesaid vertical plane, for example as indicated by the arrow P in FIGS. 5 and 6. Also, the bending mirrors 20 can be mounted such that their angle is adjustable, whereby they can be rotated for example around their vertical axis. As adjusting means, use can be made of hinge suspensions and adjusting screws. Since the practical realisation thereof is known to the professional, it will not be further described here.

Further, the device 1 of FIGS. 5 to 7 comprises several facilities to safeguard the good working order of the scanners 9-10 against disadvantageous influences, in particular against pollution. In the given example, these facilities consist of entirely closed screens 21 which surround the scanners 9 and 10 concerned and any possible other elements, such as the bending mirrors 20, and which are provided with a closed light and/or radiation-transmitting window 22 via which the scanner 9 or 10 concerned can observe the products 2. Every screen 21 is embodied as a housing with a back wall 23, side walls 24, and a front wall 25 which is preferably at least partially removable or embodied as a door 25.

The device 1 is also equipped with cleaning devices 26, which in this case work in conjunction with the windows 22, for example in the shape of a wiper 28 which can be moved via drive element 27, either or not combined with a spray system.

It is clear that a good operation can at all times be guaranteed in this manner. The screening not only makes sure that the scanners 9-10 remain dust-free, but that they can also be implemented in applications in a corrosive environment.

As a function of the application, it may also be possible to use several single screens, for example screens which only surround the scanners 9-10 on certain sides, for example at least on the sides directed towards the aforesaid track 4, and preferably also on the top side, either or not combined with a window or window opening, such that the scanners 9-10 cannot be damaged by falling products. Nor is the use of other cleaning devices than those described above excluded.

The working of the device 1 of FIGS. 5 to 7 mainly corresponds to that of FIGS. 1 to 4.

It is clear that, instead of a scanner in the shape of a video camera or the like, use can also be made of a laser scanner, whereby a laser beam is moved over the product flow 2 and whereby a detection is also carried out, such as described for example in WO 01/00333.

It should be noted that the scanners 9 and 10, as mentioned above, are preferably situated outside the planes V1 and V2, but that the embodiments whereby the scanners 9 and/or 10 are situated on one side of the track 4, but still under this track 4, also come under the present invention. For, by “on one side of the track 4” is meant that the scanners 9-10 are not situated in the middle under the track 4, but more towards the sides of said track, as a result of which they are more easily accessible. Such scanners may hereby be situated at different heights in relation to the product flow of the conveyor belt 6.

According to the present invention, it is also possible to apply one or several scanners at the top, placed at angles.

Naturally, the invention can also be applied in embodiments whereby the product flow falls straight or almost straight, whereby the laterally erected scanners then observe the back of the falling products, for example according to a horizontal or practically horizontal plane. The other side can then be observed with a third scanner, either prior to the falling motion or during the fall. By “back side” and “front side” are simply meant the two opposite sides here.

The present invention is by no means limited to the above-described embodiments represented in the accompanying figures; on the contrary, such a method and device for the inspection of products can be made according to all sorts of variants while still remaining within the scope of the invention.

Thus, it may be very important to mount the window 22 such that it forms an angle of 90°, more specifically 80° to 90°, in order to keep this window clean for a relatively long period and thus restrict the cleaning thereof to a minimum.

According to a preferred embodiment of the invention, the window extends almost vertically.

An additional characteristic which is not unimportant either, is that means can be provided in an advantageous manner in order to create an air flow along the side of the window directed towards the product flow (i.e. the side opposite to the one directed towards the scanner). In this manner is prevented that a precipitation of dirt, moisture or dust particles coming from the product flow is formed on this side. A blowing device can for example be provided in a manner known as such, which creates a thin air flow in the shape of a curtain against said side.

1. Device for the inspection of products, whereby this device (1) comprises means to convey these products (2) over a track (4) in the shape of a product flow (5) extending in the width, characterised in that it comprises at least one scanner (9-10) to inspect the products (2), whereby this scanner (9-10) is situated on one side of the aforesaid track (4).

2. Device according to claim 1, characterised in that it comprises at least two scanners (9-10), situated on either side of the aforesaid track (4) respectively, and in that the they scan the products (2) as of the lower side and/or rear side, in particular in a slanting direction.

3. Device according to claim 1, characterised in that the above-mentioned scanner or scanners (9-10) are situated, seen from above, entirely beside the aforesaid track (4).

4. Device according to claim 1, characterised in that the scanner (9-10), scanners (9-10) respectively, are erected mainly according to vertical planes (V4-V5) with their longitudinal direction, along the sides of the aforesaid track (4).

5. Device according to claim 4, characterised in that it comprises bending mirrors (20) in order to realise a scanning in a plane which is diagonal to the aforesaid track (4), which are mainly erected in the aforesaid planes (V4-V5).

6. Device according to claim 1, characterised in that it comprises one or several adjusting facilities, selected from the following series:
adjusting means in order to change the position and/or size of the angle (K1-K2) over which is being scanned;
adjusting means in the shape of control elements with which such a scanner (9-10) can be turned in the aforesaid vertical plane (V4-V5);
adjusting means in the shape of one or several bending mirrors (20) whose angle can be set.

7. Device according to claim 1, characterised in that at least one of the scanners (9-10) situated on one side of the aforesaid track (4) comprise one or several facilities to safeguard its good working order against negative influences, selected from the following series:
a screen (21) which protects the scanner (9-10) at least on its side directed towards the aforesaid track (4), and preferably also on the top side;
a mainly closed screen (21) which surrounds the scanner (9-10) and possible other elements, such as mirrors, and which is provided with a window (22) via which the scanner (9-10) can observe the products (2);
an entirely closed screen (21) which surrounds the scanner (9-10) and possible other elements, such as mirrors, and which is provided with a closed light and/or radiation-transmitting window (22) via which the scanner (9-10) can observe the products (2);
a cleaning device (26);
a cleaning device (26) which works in conjunction with a window (22) in a screen (21);
a cleaning device (26) in the shape of a wiper (28).

8. Device according to claim 1, characterised in that the means for moving the products (2) along a track (4) consist of a conveyor belt (6), which is erected such that the products (2) leave this conveyor belt (6) near its far end, and in that the above-mentioned scanner or scanners (9-10) operate in a plane (V3) immediately following this conveyor belt (6).

9. Device according to claim 1, characterised in that it comprises at least one additional scanner (13) which inspects the products (2) as of the top side or front side.

10. Device according to claim 1, characterised in that it comprises a unit (14) for sorting the inspected products (2), driven by means of a control unit (15) which is controlled by the above-mentioned scanner or scanners (9-10).

11. Device according to claimn 7, characterised in that the above-mentioned window forms an angle of 90° at the most, as of its side directed towards the product flow, with a horizontal plane extending as of the lower edge of the window.

12. Device according to claim 11, characterised in that said angle is bigger than 70°, in particular bigger than 80°, and smaller than or equal to 90°.

13. Device according to claim 11, characterised in that the window extends almost vertically.

14. Device according to claim 7, characterised in that means, such as a blowing device, are provided in order to create an air flow, in particular an air flow in the shape of a curtain, along the side of the window directed towards the product flow.

15. Device according to claim 7, characterised in that the above-mentioned window is sealed by means of a light and/or radiation-transmitting material.

16. Device according to claim 1, characterised in that an air flow is provided between the above-mentioned scanner and the above-mentioned product flow, in particular an air flow in the shape of a curtain, in order to safeguard the scanner against pollution.

17. Method for the inspection of products, whereby these products (2) are conveyed along a track (4) in the shape of a product flow (5) extending in the width and whereby these products (2) are scanned, characterised in that at least one scanner (9-10) is applied which is situated on one side (11-12) of the aforesaid track (4).

18. Method according to claim 17, characterised in that at least two scanners (9-10) are used, which are situated on either side respectively of the aforesaid track (4).

19. Method according to claim 18, characterised in that the two scanners (9-10) operate according to any of the following possibilities:
that they each scan a part of the product flow (5), such that together they scan the entire product flow (5);
that they both scan the entire product flow (5).

20. Method according to claim 17, characterised in that the above-mentioned products (2) are scanned by means of the above-mentioned scanner or scanners (9-10) along the lower side and/or rear side, in particular slantingly at an angle.

21. Method according to claim 17, characterised in that the products (2) are scanned by means of the above-mentioned scanner or scanners (9-10) while performing a coasting flight motion.

22. Method according to claim 17, characterised in that the above-mentioned products (2) are also scanned as of the top side and/or front side by means of at least one additional scanner (13).

23. Method according to claim 17, characterised in that it is used for sorting the above-mentioned products (2), whereby, as a function of the data obtained by means of the scanning, an automatic selection is carried out.

24. Method according to claim 17, characterised in that the products (2) are scanned as of at least three sides, according to main directions (R1-R2-R3) which are rotated at least 90° in relation to each other, and better still which are rotated about 120° in relation to each other.
